(19) United States
(12) Patent Application Publication
(10) Pub. No.: US 2008/0265023 A1
(43) Pub. Date: Oct. 30, 2008

(54) Wireless Access Control Reader

(76) Inventor: Shary Nassimi, Malibu, CA (US)

Correspondence Address: BOND, SCHOENECK & KING, PLLC, ONE LINCOLN CENTER, SYRACUSE, NY, 13202-1355, US

(21) Appl. No.: 11/739,806

(22) Filed: Apr. 25, 2007

(51) Int. Cl. G06K 7/01

(52) U.S. Cl. 235/382

(57) ABSTRACT

A wireless access control system having a microcontroller, a field generator, an access card reader, a proximity detector, and a self-contained energy source. Energy demands are reduced by maintaining the reader and field generator in a powered off state until the proximity detector detects the possible presentation of an access control card. The microcontroller then activates the field generator and card reader for a predetermined time period for obtaining data from the control card. If data is received, the system determined whether to grant access, or transmits the data to a host for determination whether access should be granted, and then operates a security mechanism accordingly. If data is not received within the time period, the field generator and reader are power off until the next proximity detection.

### BACKGROUND OF THE INVENTION

1. Field of the Invention

The present invention relates to access control systems and, more particularly, a system and method for providing wireless access control over a location or access point.

2. Description of the Related Art

Conventional access control systems comprise electric card readers, such as proximity card or smart card readers, which are generally wall-mounted near an access point or location, such as a door, and interconnected to a security mechanism, such as an electronically controlled lock. The access control systems will allow access to the point or location when a valid card is presented to the reader, such as by activating the lock to unlock the door. Proximity and smart cards are passive devices that are energized by an electromagnetic field generated by the access control device. When the cards are placed in proximity of the reader, the electromagnetic field is used to power the cards and generate a signal to the access control device. The signal includes information about card or card holder that is received by the access control system and used to determine whether access should be granted.

The production of an electromagnetic field of sufficient strength to power a passive card requires a significant amount of energy. As passive cards may be presented by a user desiring to obtain access to a location at any time, access control devices are provided with a constant source of energy so that the electromagnetic field is constantly available for powering a passive card presented to the reader. Conventional access control systems must thus be directly connected to power transmission lines for reasonable use. As a result, the installation of an access control system requires the placement of electrical conduit through an existing or newly constructed structure, and/or the trenching of power transmission wires to the particular location.

### BRIEF SUMMARY OF THE INVENTION

It is therefore a principal object and advantage of the present invention to provide an access control system that does not require connection to power transmission lines.

It is another object and advantage of the present invention to provide an access control system that is energy efficient.

It is a further object and advantage of the present invention to provide an access control system that is completely wireless.

In accordance with the foregoing objects and advantages, the present invention provides an access control system comprising a microcontroller, an input device interconnected to the microcontroller, an electromagnetic field generator interconnected to the microcontroller, a proximity sensor interconnected to the microcontroller, and a self-contained energy source providing power to the microcontroller, and a card reader. The microcontroller is programmed to maintain the electromagnetic field generator in a sleep mode until the proximity sensor detects the presence of a user or object. The microcontroller then activates the electromagnetic field generator, thereby providing an electromagnetic field for powering a passive card presented to the reader. Once the information from the card is read, the microcontroller returns the electromagnetic field generator to the sleep mode, thereby conserving energy and allowing the system to be powered from a self-contained energy source. The microcontroller is preferably programmed to time a predetermined period during which the electromagnetic field generator is powered after the proximity sensor detects the presence of a user or card. If the timer expires before data is received by the card reader, the microcontroller returns the electromagnetic field generator to the sleep mode.

The system may further include a wireless transceiver or interface for transmitting information received from a passive card to a host system for a determination whether access should be granted, and receiving commands from the host system indicating that access is granted or denied. The system may thus include or be operatively interconnected to a security mechanism that is controllable by the microcontroller to permit or deny access to the location.

### BRIEF DESCRIPTION OF THE DRAWINGS

The present invention will be more fully understood and appreciated by reading the following Detailed Description in conjunction with the accompanying drawings, in which:

FIG. 1 is a schematic of a preferred embodiment according to the present invention.

FIG. 2 is a flow chart of the preferred method of operating an embodiment according to the present invention.

### DETAILED DESCRIPTION OF THE INVENTION

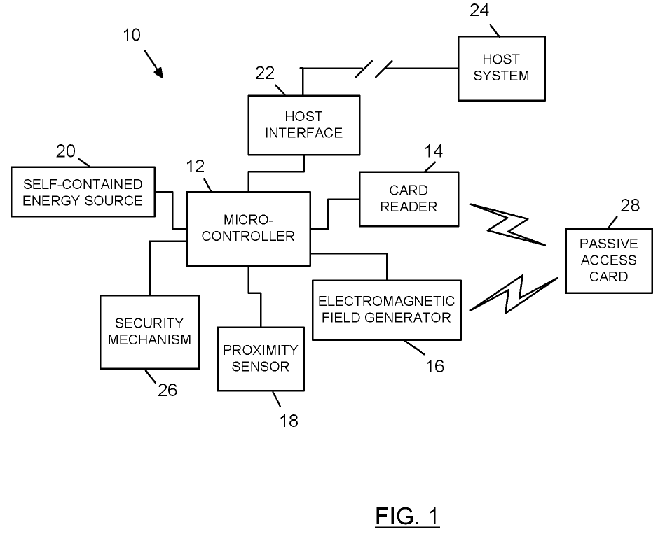

Referring now to the drawings, wherein like reference numerals refer to like parts throughout, there is seen in FIG. 1 a access control system 10 according to the present invention. System 10 comprises a microcontroller 12, a card reader 14 interconnected to microcontroller 12, an electromagnetic field generator 16 interconnected to microcontroller 12, a proximity sensor 18 interconnected to microcontroller 12, and a self-contained energy source 20 providing power to system 10. System 10 may further include a host interface 22 for transmitting and receiving data from a remotely located host system 24. System 10 may also include a security mechanism 26 that may be operated to either permit or deny access to a secure location or site. Card reader 14 is adapted for reading data transmitted by a passive card 28 placed in the field produced by electromagnetic field generator 16.

Microcontroller 12 may comprise an ATmega8 available from Atmel Corporation of San Jose, Calif. and includes the following features: 8 K bytes of In-System Programmable Flash with Read-While-Write capabilities, 512 bytes of EEPROM, 1 K byte of SRAM, 23 general purpose I/O lines, 32 general purpose working registers, three flexible Timer/Counters with compare modes, internal and external interrupts, a serial programmable USART, a byte oriented Two-wire Serial Interface, a 6-channel ADC (eight channels in TQFP and QFN/MLF packages) with 10-bit accuracy, a programmable Watchdog Timer with Internal Oscillator, an SPI serial port, and five software selectable power saving modes.

Card reader 14 and electromagnetic field generator 16 may comprise an off-the-shelf package, such as a U2270B 125 kHz Read/Write Base Station available from Atmel Corporation. Electromagnetic field generator 16 preferable includes or is interconnected to an air-core antenna that is powered by the reader package and generates the electromagnetic field that in turn powers and receives transmissions from a proximity card.

Proximity sensor 18 may comprise a motion detector, such as an infrared sensor. For example, proximity sensor may comprise a PIS04E pyroelectric infrared sensor available from Waitrony Co., Ltd. of Hong Kong. Sensor 18 should be capable of generating a signal in response to physical presence or motion which meets a predetermined threshold level, thereby indicating the likelihood that a passive card 28 has been presented to reader 14 in an attempt to gain access to the protected location.

Self-contained energy source 20 may comprise a conventional battery or battery pack, such as one or more alkaline batteries.

Host interface 22 may comprise a wireless transceiver, such as an ADF 7020 available from Analog Devices of Norwood, Mass., and is a low power, low-IF transceiver designed for operation in the license-free ISM bands at 433 MHz, 868 MHz and 915 MHz, that sends and receives data to and from host system 24. Host interface 22 may be configured to use any conventional protocols for communicating data wirelessly, such as Bluetooth, or over transmission wires, such as Wiegand. Host interface 22 may also comprise a conventional RS232 transceiver and associated 12 pin FFC jack, or comprise other conventional buses, such as USB, IEEE, 1394, IrDA, PCMCIA, or Ethernet (TCP/IP).

Host system 24 may comprise any conventional security host systems, such as a Wiegand access panel or hub having a plurality of data input/output (I/O) ports for interconnecting to devices using a comparable protocol. Host system 24 may be programmable or non-programmable, but is preferably capable of executing logic or decision-making switching to determine whether access should be granted to a user inputting data or otherwise requesting access by presenting passive card 28 to card reader 14. Host system 24 is thus also capable of transmitted commands to system 10 indicating whether access is to be permitted or denied.

Security mechanism 26 may comprise an electric door strike, or any other electrically actuated means of controlling entry or access to a location or particular piece of equipment or device.

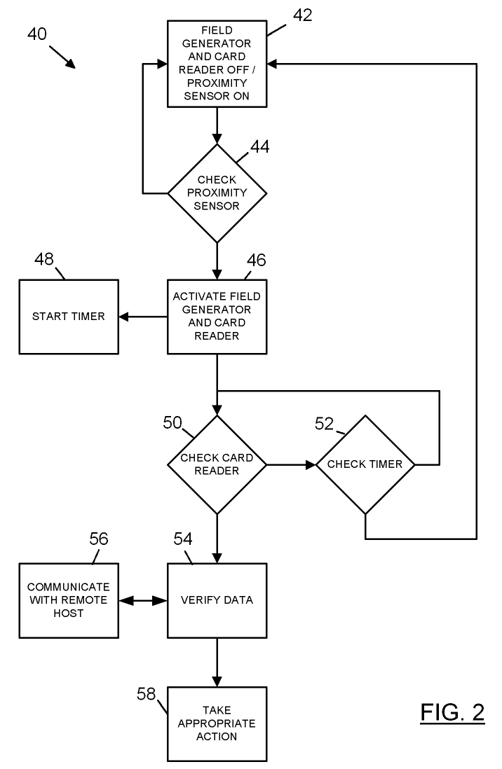

As seen in FIG. 2, microcontroller 12 is programmed to implement a power reduction process 40 that enables the use of self-contained energy source 20, such as a battery or battery pack. Process 40 begins with electromagnetic field generator 16 and reader 14 powered off and proximity sensor powered on 42. A check 44 is then performed to determine whether proximity sensor 18 has detected the presence of a user. If a user is detected at step 44, electromagnetic field generator 16 and reader 14 are activated 46. Electromagnetic field generator 16 should produce a sufficient electromagnetic field to power a passive access card presented to reader 14. A timer is then started 48 by microcontroller 12 to measure a first period. A check is performed 50 to determine whether reader 14 has received any data from a passive card. If not, the timer is checked for expiration 52 and if the timer has not expired, control returns to step 50. If the timer has expired at step 52, control returns step 42 where electromagnetic field generator 16 and reader 14 are powered off. If reader 14 is determined to have data at step 50, the data is retrieved by microcontroller 12 and processed according to conventional methods to verify the data 54 and thus determine whether access should be granted. For example, the data may be wirelessly transmitted 56 to host system 24 for comparison against predetermined access data stored remotely, or even processed locally by microcontroller 12 using look-up tables to verify whether the data is representative of a user that has been granted access to the particular location. Microcontroller 12 will then take appropriate action 58 depending on the data verification step 54, such as actuating security mechanism 26 to unlock a door or gate protecting a location.

Due to the reduced operation time of electromagnetic field generator 16 and reader 14, system 10 requires significantly less power than conventional systems and may be powered by a self-contained power source rather than having to be wired directly to power transmission lines. System 10 may thus be installed in a location without the need for conduit or trenching, thereby significantly reducing installation costs and the time involved.

What is claimed is:

1. A wireless access control system, comprising:
a microcontroller;
an electromagnetic field generator interconnected to the microcontroller;
a proximity sensor for detecting an object in a predetermined range interconnected to the microcontroller;
a card reader interconnected to the microcontroller;
a self-contained power source interconnected to the microcontroller; and
wherein the microcontroller is programmed to activate the card reader and field generator only after the proximity sensor detects an object in the predetermined range.

2. The system of claim 1, wherein the microcontroller is programmed to check the card reader for receipt of data.

3. The system of claim 2, wherein the microcontroller is programmed to measure a predetermined time period commencing when the proximity sensor detects an object.

4. The system of claim 3, wherein the microcontroller is programmed to deactivate the card reader and field generator if the proximity sensor does not detects an object before the expiration of the predetermined time period.

5. The system of claim 4, wherein the microcontroller is programmed to deactivate the card reader and field generator if the card reader received data.

6. The system of claim 5, further comprising a security mechanism operatively interconnected to the microcontroller for selectively permitting or granting access to a site.

7. The system of claim 6, wherein the proximity sensor is a motion detector.

8. The system of claim 7, wherein the security mechanism comprises an electronic lock.

9. A wireless access control system, comprising:
a microcontroller;
an electromagnetic field generator interconnected to the microcontroller;
a proximity sensor for detecting an object in a predetermined range interconnected to the microcontroller;
a card reader interconnected to the microcontroller;
a self-contained power source interconnected to the microcontroller;
a host interface interconnected to the microcontroller; and
wherein the microcontroller is programmed to activate the card reader and field generator only after the proximity sensor detects an object in the predetermined range.

10. The system of claim 9, wherein the microcontroller is programmed to transmit data received by the card reader to a remote location through the host interface.

11. The system of claim 10, wherein the microcontroller is programmed to receive at least one command from the remote location through the host interface.

12. The system of claim 11, wherein the host interface comprises a wireless transceiver.

13. The system of claim 12, further comprising a security mechanism operatively interconnected to the microcontroller for selectively permitting or granting access to a site.

14. The system of claim 13, wherein the microcontroller is programmed to operate the security mechanism according to a command received from the remote location.

15. A method for wirelessly controller access to a site, comprising the steps of:
detecting the presence of an object;
activating an electromagnetic field in response to detecting the presence of the object;
activating a card reader in response to detecting the presence of the object;
checking for the receipt of data transmitted by an access card.

16. The method of claim 15, further comprising the step of deactivating the electromagnetic field and the card reader if no data is received within a predetermined time period.

17. The method of claim 16, further comprising the step of deactivating the electromagnetic field and the card reader if data is received within the predetermined time period.
